(19) United States
(12) Patent Application Publication
(10) Pub. No.: US 2025/0173559 A1
(43) Pub. Date: May 29, 2025

(54) THREE-DIMENSIONAL PHOTONIC CHIP ARCHITECTURE BASED ON VCSEL ARRAY, APPLICATION, AND METHOD FOR CALCULATING STRUCTURE OF DNNS

(71) Applicants: Yibo DONG, Shanghai (CN); Haitao LUAN, Shanghai (CN); Qiming ZHANG, Shanghai (CN); Min GU, Shanghai (CN)

(72) Inventors: Yibo DONG, Shanghai (CN); Haitao LUAN, Shanghai (CN); Qiming ZHANG, Shanghai (CN); Min GU, Shanghai (CN)

(21) Appl. No.: 18/868,720

(22) PCT Filed: Mar. 29, 2023
(86) PCT No.: PCT/CN2023/084848

§ 371 Date: Nov. 22, 2024

(30) Foreign Application Priority Data
Jul. 27, 2022 (CN) 202210893985.X

(51) Int. Cl. G06N 3/067; G06N 3/04; G06N 3/084

(52) U.S. Cl. CPC G06N 3/067; G06N 3/04; G06N 3/084

(57) ABSTRACT

The embodiments of the present application relate to the technical field of integrated circuits, and specifically disclose a three-dimensional photonic chip architecture based on a VCSEL array, an application, and a method for calculating the structure of DNNs. The chip architecture comprises: a data input layer, used for generating two-dimensional optical data and inputting the optical data into a data processing layer; the data input layer being an addressable VCSEL array; a data processing layer, used for carrying out operations on the optical data inputted by the data input layer; a data output layer, used for collecting and outputting an operation result of the data processing layer; and the data input layer, the data processing layer and the data output layer being sequentially stacked to form the three-dimensional photonic chip architecture. The application can solve the computing power and power supply problems faced by AI operations.

This application is the National Phase of PCT International Application No. PCT/CN2023/084848 filed on Mar. 29, 2023 which claims priority to the Chinese application filed on Jul. 27, 2022, with the application number 202210893985.X, entitled ‘Three-dimensional photonic chip architecture based on VCSEL array, application, and method for calculating the structure of DNNs’. The entire disclosures of the above application are all incorporated herein by reference.

### FIELD

Embodiments of the present application relate to a technical field of integrated circuits, and specifically to a three-dimensional photonic chip architecture based on a VCSEL array, an application, and a method for calculating a structure of DNNs.

### BACKGROUND

With the rapid development of artificial intelligence (AI), the computing speed of electronic chips based on von Neumann architecture is gradually difficult to meet the needs of AI computing, and the excessive energy consumption of electronic chips may also cause serious energy crisis in the future. Currently, in order to solve this problem, neuromorphic computing realized in hardware with reference to the architecture of the human brain is gradually emerging. Photonic neural networks (PNNs) are a kind of neuromorphic computing method that uses light as an information carrier. PNNs operate at the speed of light, and the propagation process of light is usually passive and energy-free. Therefore, PNNs have obvious advantages in speed and energy consumption compared with traditional electronic chips, and are recognized as a development direction of the next generation of computing chips.

At present, many types of PNNs have been developed, and diffractive neural networks (DNNs) are one of the unique optical networks with a three-dimensional architecture. DNNs construct neuron links based on light diffraction, and their three-dimensional architectures have the advantages of high neuron density and suitability for processing two-dimensional optical data, compared with other PNNs. For example, when performing tasks such as image classification, DNNs do not need to flatten two-dimensional images into one-dimensional time series data as other two-dimensional PNNs or electronic chips do, and can directly perform image classification tasks. Therefore, the execution speed of DNNs is much better than other types of optical networks.

However, DNNs currently have the dilemma of being difficult to miniaturize, integrate, and chip. At present, the existing DNNs currently work by building large optical paths through various spatially separated optical instruments. Even if there are studies on integrating DNNs with CMOS imaging chips, it still needs a large volume of lasers for data input, and with the mask plate for optical image input, which is not practical. The volume of the entire working optical path of reported DNNs is tens of centimeters or even meters. In addition, the adjustable data input devices used in existing DNNs are spatial light modulators or digital micromirror arrays with modulation rates up to only kHz, which is much lower than the existing electronic chip frequencies, making it difficult to meet the high-speed data input requirements.

The integration of DNNs into chips is of great value in promoting their applications and is an urgent problem that needs to be solved at present. The reason for this is that there is no suitable integration platform and suitable chip architecture for 3D DNNs. The inventor realized that the existing electronic chips and optical chips are two-dimensional architectures and, therefore, cannot be used for the integrated design of DNNs.

In addition, for the design of DNNs structures in which VCSEL (Vertical-cavity surface-emitting laser) arrays are used as light sources, since the light between VCSEL array units is incoherent, traditional algorithms cannot be used to design DNNs structures, and there is no relevant literature report.

### SUMMARY

In view of the deficiencies in the prior art, embodiments of the present application provide a three-dimensional photonic chip architecture based on a VCSEL array, which can directly realize on-chip integration of the entire working optical path of DNNs, and its volume will be reduced from centimeter or meter level to millimeter or micrometer level. The chip's data input rate is more than 10⁶ times that of the data input rate of the existing DNNs, and the chip can process more data in a short time; in addition, the embodiments of the present application consider the specificities of the VCSEL array, and develop a DNNs structure design method dedicated to the VCSEL array as light sources.

In order to achieve the above objectives, the technical solutions adopted in the embodiments of the present application are as follows:

In a first aspect, an embodiment of the present application provides a three-dimensional photonic chip architecture based on a VCSEL array, comprising:
a data input layer, used for generating two-dimensional optical data and inputting the optical data into a data processing layer; the data input layer being an addressable VCSEL array;
a data processing layer, used for carrying out operations on the optical data inputted by the data input layer;
a data output layer, used for collecting and outputting an operation result of the data processing layer; and
the data input layer, the data processing layer and the data output layer being sequentially stacked to form the three-dimensional photonic chip architecture.

In the above embodiment, the addressable VCSEL array comprises a front-side light-out VCSEL array or a back-side light-out VCSEL array.

In the above embodiment, the addressable VCSEL array comprises a phase-locked VCSEL array.

In the above embodiment, the addressable VCSEL array is controlled by a manually control power supply, an external programmable control power supply, or a CMOS chip.

In the above embodiment, the data processing layer is a DNNs structure, and the DNNs structure is integrated on the addressable VCSEL array.

In the above embodiment, the 3D printing is used for printing the DNNs structure on the VCSEL array, and printing support pillars to provide support for the DNNs structure.

In the above embodiment, the bonding is used for setting up bonding points between the VCSEL array and the DNNs structure, and integrating the VCSEL array and the DNNs structure under pressure.

In the above embodiment, the DNNs structure is manufactured based on 3D printing or microelectronic processes.

In the above embodiment, preparation materials of the DNNs structure comprise at least one of organic materials, hard transparent materials, photochromic materials, and phase change materials.

In the above embodiment, the DNNs structure further comprises pulsed DNNs constructed from the VCSEL array, and the pulsed DNNs comprise a plurality of diffraction layers, each of the diffraction layers is a VCSEL array, each VCSEL array acts as a pulsed neuron in the DNNs.

In the above embodiment, the data output layer is a detector array or a general optical screen.

In the above embodiment, the detector array is integrated onto the data processing layer by bonding.

In another aspect, an embodiment of the present application provides an application of a three-dimensional photonic chip architecture based on a VCSEL array, applying to any one of the fields of face recognition, optical computing, image classification, 6G communication, optical encryption, and autonomous driving.

An embodiment of the present application also provides a method for calculating a structure of DNNs based on a VCSEL array, comprising:
constructing an output light field of the VCSEL array light in the DNNs;
calculating an amplitude distribution of the output light field; and
obtaining the DNNs structure by repeated iterations using a backpropagation algorithm and a gradient descent method.

In the above embodiment, calculating the amplitude distribution of the output light field comprises: individually calculating an output light field obtained by each unit of the VCSEL array on an output plane after passing through the DNNs, and then superimposing absolute values of the amplitudes of the output light fields of all units of the VCSEL array, to obtain the amplitude distribution of the superimposed output light fields.

Beneficial effects of the embodiments of the present application:

The three-dimensional photonic chip structure of the embodiments of the present application uses an addressable VCSEL array as the data input layer, generates two-dimensional optical data of arbitrary content to be directly inputted to the data processing layer for operation, and then the results of the operation are presented by the data output layer. The design of the chip architecture can directly realize on-chip integration of the entire working optical path of DNNs, and its volume will be reduced from centimeter or meter level to millimeter or micrometer level, which greatly promotes the practical application of DNNs. In addition, by utilizing the high modulation rate (GHz) of the VCSEL array, the chip's data input rate will be more than 10⁶ times that of the data input rate (kHz) of the existing DNNs, and the chip can process more data in a short time; and based on the characteristics of passive propagation of light, the chip has zero energy consumption during the computing process, and it only consumes energy when data is inputted and read out, and the energy consumption will be much lower than that of existing electronic chips, which can solve the energy problem faced by AI computing. The chip architecture will apply to a variety of application scenarios, such as face recognition, optical computing, image classification, 6G communication, optical encryption, and autonomous driving.

Based on the specificity of the VCSEL array light source, the embodiments of the present application propose a method for calculating the structure of DNNs, which solves the problem that existing algorithms for designing the structure of DNNs are unable to match the incoherent light source emitted between VCSEL units, so that the method can be used for the structural design of DNNs using VCSEL arrays as light sources.

### BRIEF DESCRIPTION OF THE DRAWINGS

FIG. 1 illustrates a side structural schematic diagram of a three-dimensional photonic chip architecture provided in a first embodiment;

FIG. 1-1 illustrates a structural schematic diagram of multi-layer holographic plates stack in DNNs architecture of the first embodiment;

FIG. 1-2 illustrates a structural schematic diagram of the integrated DNNs structure in the first embodiment;

FIG. 2 illustrates a side structural schematic diagram of a three-dimensional photonic chip architecture provided in a second embodiment;

FIG. 2-1 illustrates a structural schematic diagram of the DNNs architecture integrated with the addressable VCSEL array in the second embodiment;

FIG. 3 illustrates a side structural schematic diagram of a three-dimensional photonic chip architecture provided in a third embodiment;

FIG. 3-1 illustrates a structural schematic diagram of a back-side light-out VCSEL array in the third embodiment;

Wherein, 1—an addressable VCSEL array; 2—a DNNs structure; 3—a detector array; 4—a metal bonding point; 5—a light-out hole; and 6—a support pillar;

A—holographic plate 1, B—holographic plate 2, C—holographic plate 3, D—holographic plate n.

### DETAILED DESCRIPTION

In order to make the purpose, technical scheme and advantages of the present application more clearly understood, the following is a further detailed description of the present application with reference to the drawings and embodiments. It should be understood that the specific embodiments described herein are only for explaining the present application and are not intended to limit the present application. Based on the embodiments in the application, all other embodiments obtained by those of ordinary skill in the art without making creative work are within the scope of the present application.

In order to achieve the above objectives, the technical solutions adopted in the embodiments of the present application are as follows:

In a first aspect, an embodiment of the present application provides a three-dimensional photonic chip architecture based on a VCSEL array, including:
a data input layer, used for generating two-dimensional optical data and inputting the optical data into a data processing layer; the data input layer being an addressable VCSEL array;
a data processing layer, used for carrying out operations on the optical data inputted by the data input layer;
a data output layer, used for collecting and outputting an operation result of the data processing layer; and
the data input layer, the data processing layer and the data output layer being sequentially stacked to form the three-dimensional photonic chip architecture.

VCSEL is a semiconductor laser. Currently, the commonly used infrared VCSEL generally uses GaAs wafer as a substrate, and the VCSEL structure is epitaxially grown on GaAs through epitaxial technology. The light emitted by VCSEL emerges perpendicular to the substrate surface, so it is easy to implement a two-dimensional array, and the addressable control of the VCSEL array can be achieved through independent electrodes, that is, the units of any number and position in the VCSEL array can be illuminated to produce two-dimensional optical pattern data.

The addressable VCSEL array in the application has two functions. One function is to act as a data input layer to input data into a data processing layer, and convert the input electrical signals into optical signals. The addressable VCSEL array can play a role similar to that of a display screen, generating optical data with arbitrary contents to be input into the DNNs structure for computation. The other function is that the addressable VCSEL array emits laser perpendicular to the substrate, which gives it the advantage of a flat surface. Specifically, the light output surface of all units in the addressable VCSEL array is in a plane with less surface undulation. Since the three-dimensional photonic chip architecture of the present application is stacked, this allows for a tighter and more solid fit between the data processing layer and the data input layer.

Furthermore, the addressable VCSEL array can generate two-dimensional optical signals suitable for processing by the DNNs structure. It is not only the easiest laser to implement arrays among all lasers, but also VCSEL has the advantage of small size. The volume of a VCSEL array is only millimeter or micrometer level, meeting the need for small chip size.

In some embodiments, the addressable VCSEL array includes a front-side light-out VCSEL array or a back-side light-out VCSEL array.

In some embodiments, the addressable VCSEL array includes a phase-locked VCSEL array.

Further, the addressable VCSEL array includes single mode or multi-mode.

Furthermore, the addressable VCSEL array includes a normal modulation bandwidth VCSEL array or a high speed VCSEL array.

In some embodiments, the addressable VCSEL array is controlled by a manually control power supply, an external programmable control power supply, or a CMOS chip.

Specifically, CMOS chip control refers to using a CMOS integrated circuit chip to integrate the electrodes of the addressable VCSEL array through bonding, and controlling the addressable VCSEL array through the CMOS chip.

In some embodiments, the data processing layer is a DNNs structure, and the DNNs structure is integrated on the addressable VCSEL array.

By using the DNNs structure as a data processing layer and integrating it on the addressable VCSEL array, the optical image data generated by the addressable VCSEL array is directly irradiated into the DNNs structure, and the transmission and computing of the optical data can be realized without the need for connecting wires in the electronic device, and without the need for the optical waveguide structure on the silicon photonic chip.

In some embodiments, the DNNs structure is integrated on the addressable VCSEL array by 3D printing or bonding.

Further, the 3D printing is used for printing the DNNs structure on the VCSEL array, and printing support pillars to provide support for the DNNs structure; and the bonding is used for setting up bonding points between the VCSEL array and the DNNs structure, and integrating the VCSEL array and the DNNs structure under pressure.

In some embodiments, the DNNs structure is manufactured based on 3D printing or microelectronic processes.

Since the DNNs structure also composed of multi-layer holographic plates stacked and cascaded, for the 3D printed DNNs structure, the multi-layer structure can be printed directly, and at least three pillars need to be printed on the addressable VCSEL array to realize the support of the DNNs structure during the printing process of the multi-layer structure; for the DNNs structure realized by microelectronic technology, the multi-layer holographic plates need to be integrated by bonding first.

Further, when the DNNs structure is manufactured by 3D printing, the addressable VCSEL array is used as the substrate to complete the fabrication of the DNNs structure and the integration of the addressable VCSEL array and the DNNs structure; when the DNNs structure is manufactured by the microelectronic technology, the process includes first machining the DNNs structure on other substrates, and then bonding the DNNs structure to the addressable VCSEL array, wherein the bonding method includes but is not limited to adding bonding points such as metallic materials between the DNNs structure and the VCSEL array, and then pressing the two together under high pressure and at a specific temperature to achieve integration, wherein the bonding points are set in a peripheral region of the VCSEL array and will not block transmission of optical signals emitted by the VCSEL to the DNNs structure.

In some embodiments, preparation materials of the DNNs structure include at least one of organic materials, hard transparent materials, photochromic materials, and phase change materials.

Further, the organic materials include transparent photosensitive resin materials, including, but not limited to, photoresist, which are materials used to manufacture DNNs structures through 3D printing.

Further, the hard transparent materials include, but are not limited to, one of quartz and sapphire, and are materials used in microelectronics processing of DNNs structures. Transparency means that the materials have a certain transmittance for the light emitted from the VCSEL. The long-term stability of the chip prepared using this type of materials is also relatively excellent.

Further, the photochromic materials are materials that can adjust the transmittance by light, and their characteristic is that this transmittance modulation can be restored. Therefore, it is possible to realize reconfigurable DNNs by taking advantage of their characteristic. For organic and hard transparent materials, once the DNNs are fabricated, they can only realize the specific computing functions designed for them. In contrast, for photochromic materials, the functions of the DNNs can be reset, that is, once the transmittance of the photochromic materials have been restored to its initial state, the transmittance of the photochromic materials can be re-regulated to realize new functions of the DNNs.

Further, phase change materials can also realize the resettable function of the DNNs.

In some embodiments, the DNNs structure further includes pulsed DNNs constructed from the VCSEL array, and the pulsed DNNs include a plurality of diffraction layers, each of the diffraction layers is a VCSEL array, each VCSEL array acts as a pulsed neuron in the DNNs.

In some embodiments, the data output layer includes a detector array or a general optical screen.

Preferably, the data output layer is a detector array. The function of the detector array is to collect the operation results of the DNNs and act as a data output port to convert the optical data into electrical signals for output.

As for the ordinary optical screen as the data output layer, the DNNs structure operation results can be directly presented on the screen in the form of light intensity distribution. For example, the DNNs structure can be used to perform the recognition task of four handwritten digits from 0 to 3, and the content of which is to be able to distinguish different handwritten digits. After the DNNs structure operation, four light spots are output. The first light spot is the brightest when the input is the digit 0, and the fourth light spot is the brightest when the input is the digit 3, and the results of the operation can be read from the presentation of the ordinary optical screen.

Further, the detector array is integrated onto the data processing layer by bonding, specifically by setting bonding points on the DNNs structure. The bonding points are set in the peripheral region of the optical signal transmission, which will not block the optical signal transmission from the DNNs structure to the detector array.

The three-dimensional photonic chip architecture based on the VCSEL array of the embodiment of the present application can be applied to the fields of face recognition, optical computing, image classification, 6G communication, optical encryption, and autonomous driving.

An embodiment of the present application also provides a method for calculating a structure of DNNs based on a VCSEL array, including:
constructing an output light field of the VCSEL array light;
calculating an amplitude distribution of the output light field; and
obtaining the DNNs structure by repeated iterations using a backpropagation algorithm and a gradient descent method.

In some embodiments, calculating the amplitude distribution of the output light field includes: individually calculating an output light field obtained by each unit of the VCSEL array on an output plane after passing through the DNNs, and then superimposing absolute values of the amplitudes of the output light fields of all units of the VCSEL array, to obtain the amplitude distribution of the superimposed output light fields.

Based on the specificity of the VCSEL array light source, the embodiment of the present application proposes the method for calculating the structure of DNNs, which solves the problem that existing algorithms for designing the structure of DNNs are unable to match the incoherent light source emitted between VCSEL units, so that the method can be used for the structural design of DNNs using VCSEL arrays as light sources.

### First Embodiment

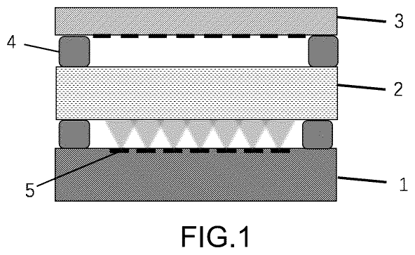

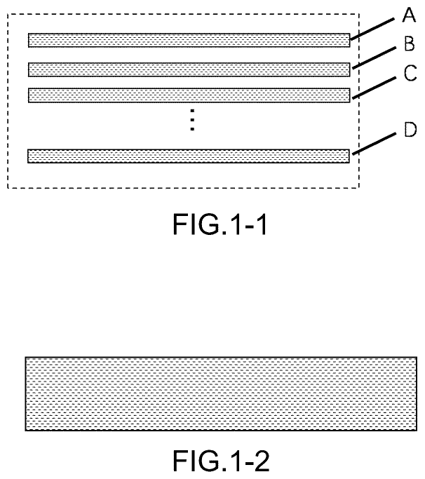

A three-dimensional photonic chip architecture based on a VCSEL array, including:
a data input layer, used for generating two-dimensional optical data and inputting the optical data into a data processing layer; the data input layer being an addressable VCSEL array;
a data processing layer, used for carrying out operations on the optical data inputted by the data input layer;
a data output layer, used for collecting and outputting an operation result of the data processing layer; and
the data input layer, the data processing layer and the data output layer being sequentially stacked to form the three-dimensional photonic chip architecture. Referring to FIG. 1, which is a side structural schematic diagram of the three-dimensional photonic chip architecture provided in the embodiment.

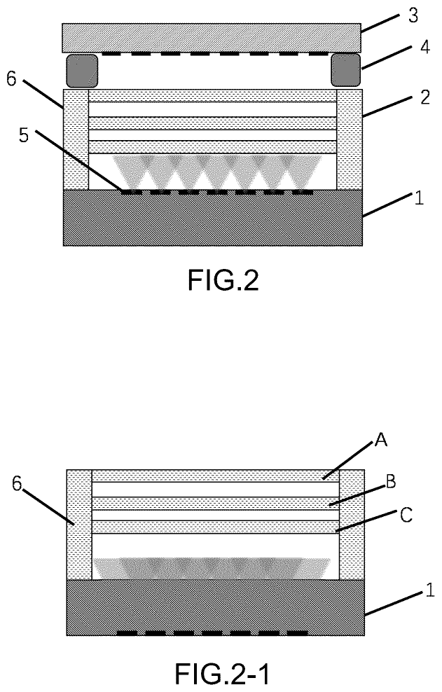

In the embodiment, the data processing layer is a DNNs structure 2, the DNNs structure 2 is integrated by microelectronic processing, and the DNNs structure 2 is prepared from quartz materials. Specifically, multi-layer quartz holographic plates (A, B, C, D in FIG. 1-1, i.e., holographic plate 1, holographic plate 2, holographic plate 3, holographic plate n) are first bonded by high voltage, and an integrated DNNs structure 2 is obtained as shown in FIG. 1-2. Then setting metal bonding points 4 between the integrated DNNs structure 2 and the addressable VCSEL array 1 to realize the integration of the two, in which the metal bonding points 4 are set in the peripheral region of the VCSEL array, which will not block the data transmission between the addressable VCSEL array 1 and the DNNs structure 2. The data output layer is a detector array 3, which is bonded by setting metal bonding points 4 between the DNNs structure 2 and the detector array 3, wherein the metal bonding points 4 are set in the peripheral region of the transmission of the optical signals, which will not block the transmission of the optical signals from the DNNs structure 2 to the detector array 3.

The application uses an addressable VCSEL array 1. As an active device, VCSEL can generate laser light. The addressable VCSEL array 1 is a light source array composed of multiple VCSELs arranged two-dimensionally on a plane. By controlling the brightness of the VCSELs, two-dimensional optical image data can be generated. The addressable VCSEL array 1 is equipped with a light outlet hole 5, the optical image data generated by the addressable VCSEL array 1 is directly irradiated into the DNNs structure 2 through the light outlet hole 5, propagated inside it to complete arithmetic operations, and then an optical signal output with the operation result. The optical signal is irradiated above the detector array 3, and is expressed in the form of different light intensity distributions. The light is irradiated into different areas of the detector array, and the light intensity distributions represent the operation result of the data. The detector array 3 converts the optical signal into an electrical signal, and outputs the results of the arithmetic operations.

The addressable VCSEL array is a front-side light-out VCSEL array.

Further, the addressable VCSEL array includes single mode or multi-mode, and the addressable VCSEL array includes a normal modulation bandwidth VCSEL array or a high speed VCSEL array.

There is no limitation on the manipulation of the addressable VCSEL array in the embodiment, including one of manually control power supply, external programmable control power supply, or CMOS chips.

The three-dimensional photonic chip architecture provided in the present embodiment can be applied in the fields of face recognition, optical computing, image classification, 6G communication, optical encryption, and autonomous driving. For example, in a face recognition system, the three-dimensional photonic chip architecture can recognize the face information more quickly and accurately in a more massive database, to complete the confirmation of identity.

The three-dimensional photonic chip architecture of the embodiment can directly realize on-chip integration of the entire working optical path of DNNs, and its volume will be reduced from centimeter or meter level to millimeter or micrometer level, which greatly promotes the practical application of DNNs. In addition, by utilizing the high modulation rate (GHz) of the VCSEL array, the chip's data input rate will be more than 10⁶ times that of the data input rate (kHz) of the existing DNNs, and the chip can process more data in a short time; and based on the characteristics of passive propagation of light, the chip has zero energy consumption during the computing process, and it only consumes energy when data is inputted and read out, and the energy consumption will be much lower than that of existing electronic chips, which can solve the energy problem faced by AI computing.

### Second Embodiment

A three-dimensional photonic chip architecture based on a VCSEL array, including:
a data input layer, used for generating two-dimensional optical data and inputting the optical data into a data processing layer; the data input layer being an addressable VCSEL array;
a data processing layer, used for carrying out operations on the optical data inputted by the data input layer;
a data output layer, used for collecting and outputting an operation result of the data processing layer; and
the data input layer, the data processing layer and the data output layer being sequentially stacked from bottom to top to form the three-dimensional photonic chip architecture.

Referring to FIG. 2, which is a side structural schematic diagram of the three-dimensional photonic chip architecture provided in the embodiment.

In the embodiment, the data processing layer is a DNNs structure 2, the DNNs structure 2 is integrated by 3D printing, and the DNNs structure 2 is prepared by photoresist. Specifically, multi-layer quartz holographic plates, including A, B, D, i.e., holographic plate 1, holographic plate 2, . . . , holographic plate n (n>2), are directly printed on the addressable VCSEL as shown in FIG. 2-1. The support of the DNNs structure 2 is realized by printing three support pillars 6 on the addressable VCSEL array 1, to obtain the integrated DNNs structure 2. Wherein the support pillars 6 are set in the peripheral region of the VCSEL array, which will not block the data transmission between the addressable VCSEL array 1 and the DNNs structure 2. The data output layer is a detector array 3, and the bonding is realized by setting metal bonding points 4 between the DNNs structure 2 and the detector array 3, wherein the metal bonding points 4 are set in the peripheral region of the transmission of the optical signals, and will not block the transmission of the optical signals from the DNNs structure 2 to the detector array 3.

The application uses an addressable VCSEL array 1. As an active device, VCSEL can generate laser light. The addressable VCSEL array 1 is a light source array composed of multiple VCSELs arranged two-dimensionally on a plane. By controlling the brightness of the VCSELs, two-dimensional optical image data can be generated. The addressable VCSEL array 1 is equipped with a light outlet hole 5, the optical image data generated by the addressable VCSEL array 1 is directly irradiated into the DNNs structure 2 through the light outlet hole 5, propagated inside it to complete arithmetic operations, and then an optical signal output with the operation result. The optical signal is irradiated above the detector array 3, and is expressed in the form of different light intensity distributions. The light is irradiated into different areas of the detector array, and the light intensity distributions represent the operation result of the data. The detector array 3 converts the optical signal into an electrical signal, and outputs the results of the arithmetic operations.

The addressable VCSEL array is a front-side light-out VCSEL array.

Further, the addressable VCSEL array includes single mode or multi-mode, and the addressable VCSEL array includes a normal modulation bandwidth VCSEL array or a high speed VCSEL array.

There is no limitation on the manipulation of the addressable VCSEL array in the embodiment, including one of manually control power supply, external programmable control power supply, or CMOS chips.

The three-dimensional photonic chip architecture provided in the present embodiment can be applied in the fields of face recognition, optical computing, image classification, 6G communication, optical encryption, and autonomous driving.

The three-dimensional photonic chip architecture of the embodiment can directly realize on-chip integration of the entire working optical path of DNNs, and its volume will be reduced from centimeter or meter level to millimeter or micrometer level, which greatly promotes the practical application of DNNs. In addition, by utilizing the high modulation rate (GHz) of the VCSEL array, the chip's data input rate will be more than 10⁶ times that of the data input rate (kHz) of the existing DNNs, and the chip can process more data in a short time; and based on the characteristics of passive propagation of light, the chip has zero energy consumption during the computing process, and it only consumes energy when data is inputted and read out, and the energy consumption will be much lower than that of existing electronic chips, which can solve the energy problem faced by AI computing.

### Third Embodiment

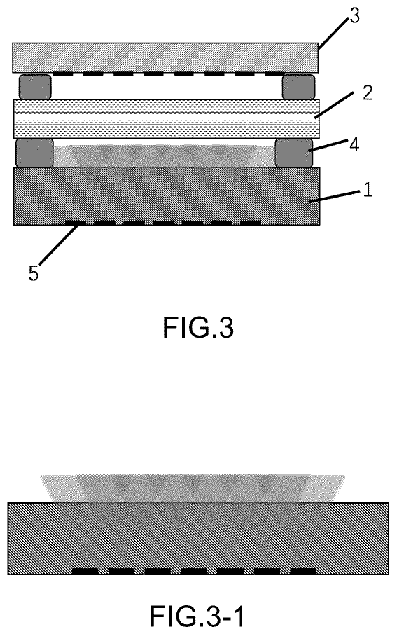

A three-dimensional photonic chip architecture based on a VCSEL array, including:
a data input layer, used for generating two-dimensional optical data and inputting the optical data into a data processing layer; the data input layer being an addressable VCSEL array;
a data processing layer, used for carrying out operations on the optical data inputted by the data input layer;
a data output layer, used for collecting and outputting an operation result of the data processing layer; and
the data input layer, the data processing layer and the data output layer being sequentially stacked from bottom to top to form the three-dimensional photonic chip architecture. Referring to FIG. 3, which is a side structural schematic diagram of the three-dimensional photonic chip architecture provided in the embodiment.

In the embodiment, the data processing layer is a DNNs structure 2, the DNNs structure 2 is integrated by microelectronic processing, and the DNNs structure 2 is prepared from photochromic materials. Specifically, multi-layer quartz holographic plates of the photochromic materials are first bonded by high voltage, and an integrated DNNs structure 2 is obtained. Then setting metal bonding points 4 between the integrated DNNs structure 2 and the addressable VCSEL array 1 to realize the integration of the two, in which the metal bonding points 4 are set in the peripheral region of the VCSEL array, which will not block the data transmission between the addressable VCSEL array 1 and the DNNs structure 2. The data output layer is a detector array 3, which is bonded by setting metal bonding points 4 between the DNNs structure 2 and the detector array 3, wherein the metal bonding points 4 are set in the peripheral region of the transmission of the optical signals, which will not block the transmission of the optical signals from the DNNs structure 2 to the detector array 3.

The application uses an addressable VCSEL array 1. As an active device, VCSEL can generate laser light. The addressable VCSEL array 1 is a light source array composed of multiple VCSELs arranged two-dimensionally on a plane. By controlling the brightness of the VCSELs, two-dimensional optical image data can be generated. The addressable VCSEL array 1 is equipped with a light outlet hole 5, the optical image data generated by the addressable VCSEL array 1 is directly irradiated into the DNNs structure 2 through the light outlet hole 5, propagated inside it to complete arithmetic operations, and then an optical signal output with the operation result. The optical signal is irradiated above the detector array 3, and is expressed in the form of different light intensity distributions. The light is irradiated into different areas of the detector array, and the light intensity distributions represent the operation result of the data. The detector array 3 converts the optical signal into an electrical signal, and outputs the results of the arithmetic operations.

The addressable VCSEL array is a back-side light-out VCSEL array. As shown in FIG. 3-1, specifically the back-side light-out VCSEL array is that light passes through the substrate of the VCSEL and exits from the other side, using this structure is more convenient to accomplish integration with DNNs structures due to the excellent flatness of the backside of the VCSEL.

Further, the addressable VCSEL array includes single mode or multi-mode, and the addressable VCSEL array includes a normal modulation bandwidth VCSEL array or a high speed VCSEL array.

There is no limitation on the manipulation of the addressable VCSEL array in the embodiment, including one of manually control power supply, external programmable control power supply, or CMOS chips.

The three-dimensional photonic chip architecture provided in the present embodiment can be applied in the fields of face recognition, optical computing, image classification, 6G communication, optical encryption, and autonomous driving.

The three-dimensional photonic chip architecture of the embodiment can directly realize on-chip integration of the entire working optical path of DNNs, and its volume will be reduced from centimeter or meter level to millimeter or micrometer level, which greatly promotes the practical application of DNNs. In addition, by utilizing the high modulation rate (GHz) of the VCSEL array, the chip's data input rate will be more than 10⁶ times that of the data input rate (kHz) of the existing DNNs, and the chip can process more data in a short time; and based on the characteristics of passive propagation of light, the chip has zero energy consumption during the computing process, and it only consumes energy when data is inputted and read out, and the energy consumption will be much lower than that of existing electronic chips, which can solve the energy problem faced by AI computing.

### Forth Embodiment

A method for calculating a structure of DNNs based on a VCSEL array, including:
S1, constructing a propagation process and an output light field of the VCSEL array light in the DNNs;
S2, calculating an amplitude distribution of the output light field based on the output light field of the VCSEL array light in the DNNs: individually calculating an output light field obtained by each unit of the VCSEL array on an output plane after passing through the DNNs, and then superimposing absolute values of the amplitudes of the output light fields of all units of the VCSEL array, to obtain the amplitude distribution of the superimposed output light fields.
S3, obtaining the DNNs structure by repeated iterations using a backpropagation algorithm and a gradient descent method.

Based on the specificity of the VCSEL array light source, the embodiment of the present application proposes the method for calculating the structure of DNNs, which solves the problem that existing algorithms for designing the structure of DNNs are unable to match the incoherent light source emitted between VCSEL units, so that the method can be used for the structural design of DNNs using VCSEL arrays as light sources.

Specifically:
constructing an output light field of the VCSEL array light after passing through the DNNs;
calculating an amplitude distribution of the output light field, according to the output light field of the VCSEL array light after passing through the DNNs;
defining a loss function, and a difference between the amplitude distribution of the output light field and a target amplitude distribution; and
optimizing the DNNs structure by repeated iterations using a backpropagation algorithm and a gradient descent method, to gradually reduce a value of the loss function, and finally obtaining the DNNs structure.

It is noted that the above is only the preferred embodiment of the present application, and is not intended to limit the patent scope of the present application. Any equivalent transformations utilizing the contents of the specification and the drawings of the present application, or directly or indirectly applying them in other related technology fields, are all similarly included in the scope of patent protection of the present application.

1. A three-dimensional photonic chip architecture based on a VCSEL array, comprising:
a data input layer, used for generating two-dimensional optical data and inputting the optical data into a data processing layer; the data input layer being an addressable VCSEL array;
a data processing layer, used for carrying out operations on the optical data inputted by the data input layer, wherein the data processing layer comprises a DNNs structure, and the DNNs structure is integrated on the addressable VCSEL array by 3D printing or bonding;
a data output layer, used for collecting and outputting an operation result of the data processing layer; and
the data input layer, the data processing layer and the data output layer being sequentially stacked to form the three-dimensional photonic chip architecture.

2. The three-dimensional photonic chip architecture based on the VCSEL array as claimed in claim 1, wherein the addressable VCSEL array comprises a front-side light-out VCSEL array or a back-side light-out VCSEL array.

3. The three-dimensional photonic chip architecture based on the VCSEL array as claimed in claim 1, wherein the addressable VCSEL array comprises a phase-locked VCSEL array.

4. The three-dimensional photonic chip architecture based on the VCSEL array as claimed in claim 1, wherein the addressable VCSEL array is controlled by a manually control power supply, an external programmable control power supply, or a CMOS chip.

5. (canceled)

6. (canceled)

7. The three-dimensional photonic chip architecture based on the VCSEL array as claimed in claim 1, wherein the 3D printing is used for printing the DNNs structure on the VCSEL array, and printing support pillars to provide support for the DNNs structure.

8. The three-dimensional photonic chip architecture based on the VCSEL array as claimed in claim 1, wherein the bonding is used for setting up bonding points between the VCSEL array and the DNNs structure, and integrating the VCSEL array and the DNNs structure under pressure.

9. The three-dimensional photonic chip architecture based on the VCSEL array as claimed in claim 1, wherein the DNNs structure is manufactured based on 3D printing or microelectronic processes.

10. The three-dimensional photonic chip architecture based on the VCSEL array as claimed in claim 1, wherein preparation materials of the DNNs structure comprise at least one of organic materials, hard transparent materials, photochromic materials, and phase change materials.

11. The three-dimensional photonic chip architecture based on the VCSEL array as claimed in claim 10, wherein the DNNs structure further comprises pulsed DNNs constructed from the VCSEL array, and the pulsed DNNs comprise a plurality of diffraction layers, each of the diffraction layers is a VCSEL array, each VCSEL array acts as a pulsed neuron in the DNNs.

12. The three-dimensional photonic chip architecture based on the VCSEL array as claimed in claim 1, wherein the data output layer comprises a detector array or a general optical screen.

13. The three-dimensional photonic chip architecture based on the VCSEL array as claimed in claim 12, wherein the detector array is integrated onto the data processing layer by bonding.

14. The three-dimensional photonic chip architecture based on the VCSEL array as claimed in claim 1, wherein the architecture is applied to any one of the fields of face recognition, optical computing, image classification, 6G communication, optical encryption, and autonomous driving.

15. A method for calculating a structure of DNNs based on a VCSEL array, comprising:
constructing an output light field of the VCSEL array light after passing through the DNNs;
calculating an amplitude distribution of the output light field, according to the output light field of the VCSEL array light after passing through the DNNs;
defining a loss function, and a difference between the amplitude distribution of the output light field and a target amplitude distribution; and
optimizing the DNNs structure by repeated iterations using a backpropagation algorithm and a gradient descent method, to gradually reduce a value of the loss function, and finally obtaining the DNNs structure.

16. The method for calculating the structure of DNNs based on the VCSEL array as claimed in claim 15, wherein calculating the amplitude distribution of the output light field comprises:
individually calculating an output light field obtained by each unit of the VCSEL array on an output plane after passing through the DNNs;
superimposing absolute values of the amplitudes of the output light fields of all units of the VCSEL array, to obtain the amplitude distribution of the superimposed output light fields.
